(19) United States
(12) Patent Application Publication
(10) Pub. No.: US 2013/0283750 A1
(43) Pub. Date: Oct. 31, 2013

(54) VACUUM PICKUP ATTACHMENT FOR RIDING LAWN MOWER

(71) Applicant: Bernard Dominic Giannetti, IV, Wickliffe, OH (US)

(72) Inventor: Bernard Dominic Giannetti, IV, Wickliffe, OH (US)

(21) Appl. No.: 13/460,002

(22) Filed: Apr. 30, 2012

(51) Int. Cl. A01D 43/06; B23P 11/00; B23P 17/00

(52) U.S. Cl. 56/202; 29/428; 29/525.08; 29/525.03

(57) ABSTRACT

A vacuum pickup attachment for a riding lawn mower and method of using the attachment includes the vacuum pickup attachment being removably attached to the riding lawn mower for receiving lawn refuse. The vacuum pickup attachment has a first position where a mouth of the vacuum pickup attachment is disposed at a first elevated location that is out of the way of the free flow of material that is moving through an exit portal of a cutter deck away from rotating blades disposed under the cutter deck of the riding lawn mower. The vacuum pickup attachment has a second position where the mouth of the vacuum pickup attachment is disposed at a second elevated location that is in the path of the stream of material that is being ejected through the exit portal by the rotating blades disposed under the cutter deck.

### TECHNICAL FIELD OF THE DISCLOSURE

The present disclosure is a mounting bracket allowing a user to removably attach a vacuum pickup to the cutter deck of a riding-type of lawn mower in either one of two locations: (1) at the exit portal of the cutter deck where debris comes from the rotating blades, thereby allowing the vacuum pickup to receive the debris, or (2) above the exit portal such that the vacuum pickup is in a storage location from which it can be readily retrieved for use in the other location.

### BACKGROUND OF THE DISCLOSURE

It is an established reality that grass clippings must be removed from lawns to prevent a heavy thatch of clippings from building up which will smother new grass growth, provide a hiding place for destructive insects and provide an environment suitable for rapid growth of mold, fungus, and other lawn diseases. The removal of grass clippings has been accomplished by a variety of techniques ranging from a manual rake to elaborate vacuum cleaning systems. The manual rake functions satisfactorily for a relatively small area but when large grass tracts are groomed that method is not practical. For large tracts, tractor power mowers are normally used and grass clipping are removed by relatively sophisticated vacuum and vacuum sweeper devices.

Riding lawn mowers which are specifically designed as such or which are converted yard and garden tractors produce a large volume of grass clippings which must be removed from lawns for the reasons stated above. A relatively large variety of yard and garden tractors are used by home owners and lawn-maintenance companies to carry and power a wide variety of attachments, including vacuum producing machinery of the sort alluded to above as well as receptacles to store the captured clippings or other lawn debris including leaves and sometimes not simply yard waste but also refuse of the sort that might also be vacuumed from non-lawn areas such as parking lots and playgrounds.

### SUMMARY OF THE DISCLOSURE

According to an embodiment of the invention, a vacuum pickup attachment for a riding lawn mower includes the vacuum pickup attachment being removably attached to the riding lawn mower for receiving lawn refuse. The vacuum pickup attachment has a first position where a mouth of the vacuum pickup attachment is disposed at a first elevated location that is out of the way of the free flow of material that is moving through an exit portal of a cutter deck away from rotating blades disposed under the cutter deck of the riding lawn mower. The vacuum pickup attachment has a second position where the mouth of the vacuum pickup attachment is disposed at a second elevated location that is in the path of the stream of material that is being ejected through the exit portal by the rotating blades disposed under the cutter deck.

According to another embodiment of the invention, a method of attaching a vacuum pickup attachment to a riding lawn mower includes removably attaching the vacuum pickup attachment to the riding lawn mower for receiving lawn refuse. The vacuum pickup attachment can be affixed in a first position where a mouth of the vacuum pickup attachment is disposed at a first elevated location that is out of the way of the free flow of material that is moving through an exit portal of a cutter deck away from rotating blades disposed under the cutter deck of the riding lawn mower. The vacuum pickup attachment can be affixed in a second position where the mouth of the vacuum pickup attachment is disposed at a second elevated location that is in the path of the stream of material that is being ejected through the exit portal by the rotating blades disposed under the cutter deck.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting.

Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

Often, similar elements may be referred to by similar numbers in various figures (FIGs) of the drawing, in which case typically the last two significant digits may be the same, the most significant digit being the number of the drawing figure (FIG).

FIG. 1 is an oblique perspective view of the mounting bracket for a riding type of lawn mower according to the present invention.

FIG. 2A is an orthogonal side view of the mounting bracket for a riding type of lawn mower according to the present invention.

FIG. 2B is an orthogonal front view of the mounting bracket for a riding type of lawn mower according to the present invention.

FIG. 3A is an oblique perspective view of the right front wheel and the exit portal of the cutting deck of an exemplary lawn mower according to the present invention.

FIG. 3B is an oblique perspective view of the right front wheel and the exit portal of the cutting deck with a vacuum pickup disposed over the exit portal according to the present invention.

FIG. 4A is an oblique perspective view of the right front wheel and the exit portal of the cutting deck with the mounting bracket mounted above the exit portal according to the present invention.

FIG. 4B is an oblique perspective view of the right front wheel and the exit portal of the cutting deck with the vacuum pickup shown being held out of the path of debris moving from the exit portal according to the present invention.

### DETAILED DESCRIPTION OF THE DISCLOSURE

The present disclosure reveals a mounting bracket 10 for a riding type of lawn mower to which a vacuum pickup attachment 56 can be removably attached for the purpose of, as needed, receiving such lawn refuse as grass clippings and leaves. The mounting bracket 10 serves the purpose of positioning the mouth of the vacuum pickup 56 at an elevated location where, when not needed for receiving lawn debris, it is in a safe and handy storage location that is out of the way of the free flow of material that is moving away from the high-speed rotating blades of the mower. That is to say, whereas the basic design of a given riding lawn mower 38 might be such as to removably receive a vacuum pickup attachment 56 such that it is in the path of the stream of material that is ejected by the lawn mower blades, the present disclosure reveals a bracket 10 that allows the vacuum pickup attachment 56 to be removably attached outside of, or away from, the stream of ejected material, thereby providing a convenient storage place for the vacuum pickup when it is not needed or otherwise intended for use when the mower itself is being used.

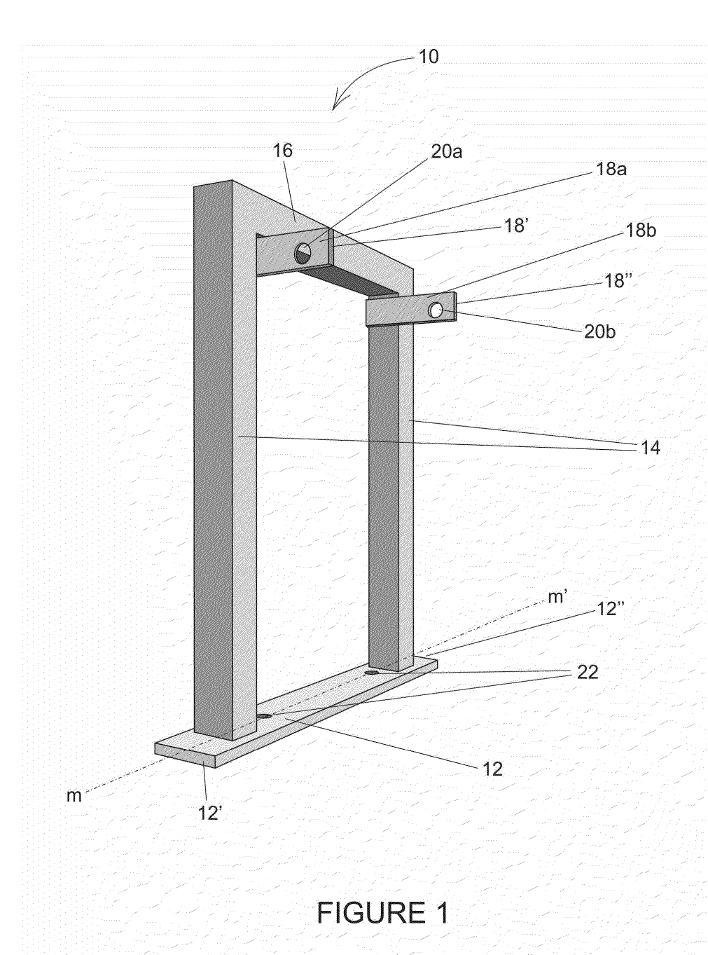

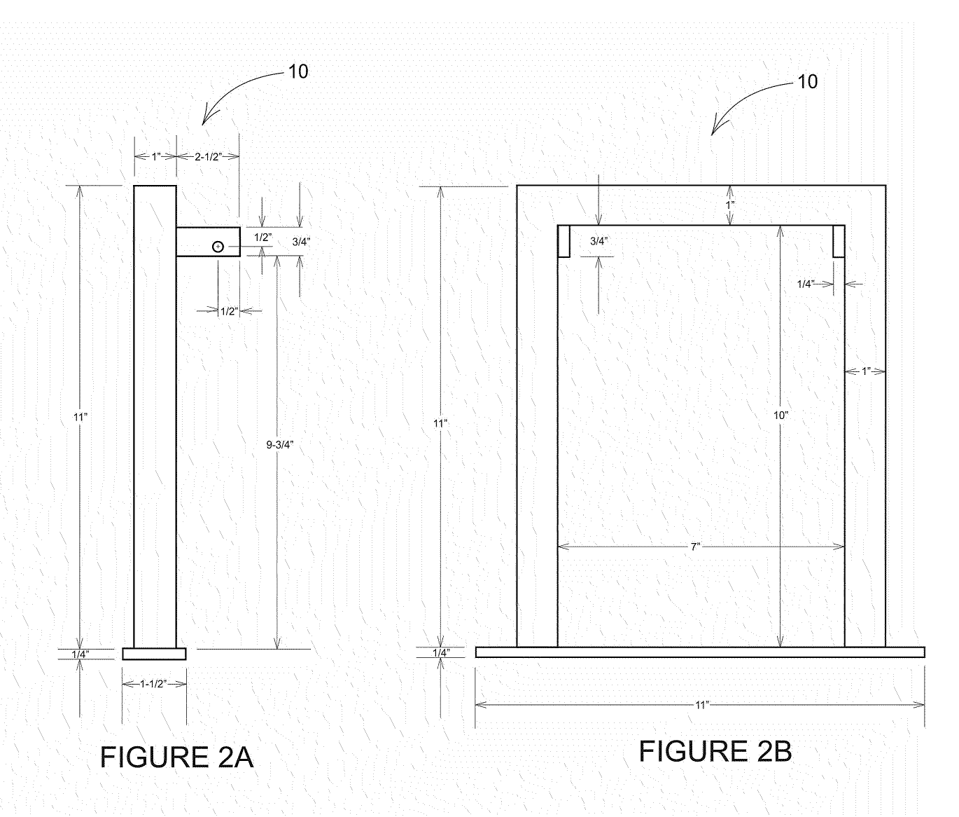

Referring now to FIG. 1, there is shown in oblique perspective view a mounting bracket 10 according to the present disclosure. The bracket 10 consists of a base portion 12, made of a rigid material such as metal (not plastic) having a thickness x of about 0.125 to about 0.25″ inches and preferably about 0.25 inches. Base portion 12 can have a length y of about 9 to about 14 inches long and preferably about 11 inches long. Base portion 12 can have a width z of about 1″ to about 2″ inches wide and preferably about 1.5 inches wide. (FIGS. 2A,2B show the preferred dimensions of the mounting bracket 10.) Welded to the base 12 are two upright or vertical portions 14 which are joined by way of a horizontal top member 16. The vertical portions 14 and the horizontal top section 16 are made of box sections of about 0.75 to about 1.25 inches square and preferably about 1 inch square. The vertical portions 14 have an overall height d of about 9 inches to about 14″ inches and preferably about 11 inches. The vertical portions 14 having a separation distance e of about 5 inches to about 9 inches and preferably about 7 inches.

Also evident in FIG. 1 are two mounting holes 22 in the base 12, the holes being spaced apart a distance f about 4.5 to about 6.5 inches and preferably about 5.5 inches and disposed along a middle line m-m′ and equidistant from the ends 12′,12″ of the base. Each of the holes 22 has a diameter of about 0.375 inches. Yet further evident in FIG. 1 are two tabs 18a,18b protruding outward, perpendicular to the plane of the vertical portions 14 and the horizontal top section 16, a distance g of about 1.25 to about 1.75 inches and preferably about 1.5 inches. Each of the tabs 18a,18b has a single hole 20a,20b respectively, each having a diameter of about ⅜ inch. Each tab 18a, 18b has a thickness of about 0.25 inches and measures a distance h about 0.75 inches in vertical dimension, and each is welded to the respective vertical member 14. The center of each hole 20a, 20b is respectively disposed about 0.5 inches inward from the respective front ends 18′, 18″ of the tabs 18a, 18b and about 0.5 inches down from the upper most portion of each tab.

The entire bracket assembly 10 is preferably made of steel. The bracket assembly 10 can be welded together or molded into a single or unitary rigid structure.

FIG. 2A shows the bracket 10 in orthogonal side view with the preferred dimensions being shown. FIG. 2B shows the bracket 10 in orthogonal front view with the preferred dimensions being shown.

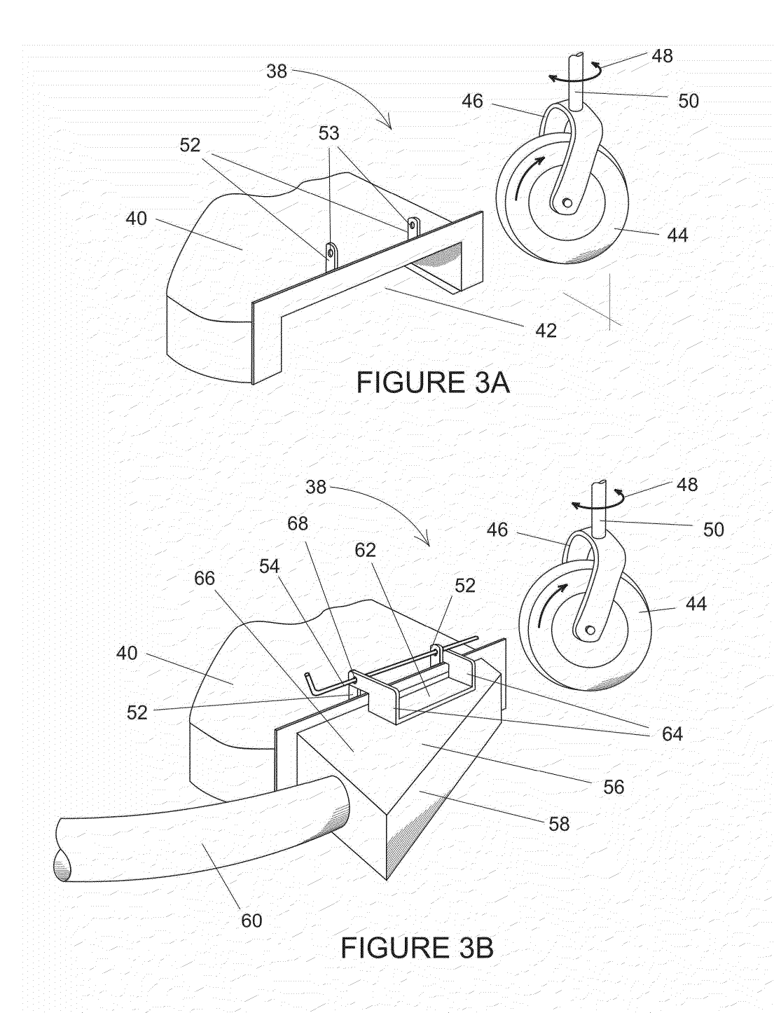

FIG. 3A is an oblique perspective view of cutter deck 40 and exit portal 42 of an exemplary riding lawn mower 38. Cutter blades (not shown) are housed within the cutter deck 40. Right front steering wheel 44 and axle bracket 46 orient the eye to the relevant part of the riding lawn mower 38; the wheel 44 swivels as shown by two-headed arrow 48 about vertical steering shaft 50. On top of the cutter deck 40 are disposed two steel deck tabs 52, each having a hole 53 for receiving a lynch pin 54 that is shown in FIG. 3B.

FIG. 3B shows a vacuum pickup attachment 56 attached to exit portal 42 of the cutter deck 40. The vacuum pickup attachment 56 is comprised of, in this schematic view, a plenum chamber 58 and a flexible vacuum-conveying pipe 60. The vacuum pickup attachment 56 covers the exit portal 42 (not visible in this view) and receives material that is ejected by the rotating cutter blades, which are not shown in any of the FIGURES. A plenum bracket 62, having a base section 63 mounted to the plenum and two vertical portions 64 attached to the base section and thereby affixed to the top 66 of the plenum chamber 58. The vertical portions 64 of the plenum bracket 62 have holes 68 (only one hole is visible in FIG. 3B) for receiving lynch pin 54 which connects the vacuum pickup attachment 56 to the steel tabs 52. The vertical portions 64 having end portions 64a and 64b of the plenum bracket 62 project beyond the end surface 62a of the plenum chamber. Note that the end surface 62a of the plenum surface has an opening which is disposed against the exit portal 42. The holes 68 are disposed within the end portions 64a and 64b of the vertical portions 64 of plenum bracket 62.

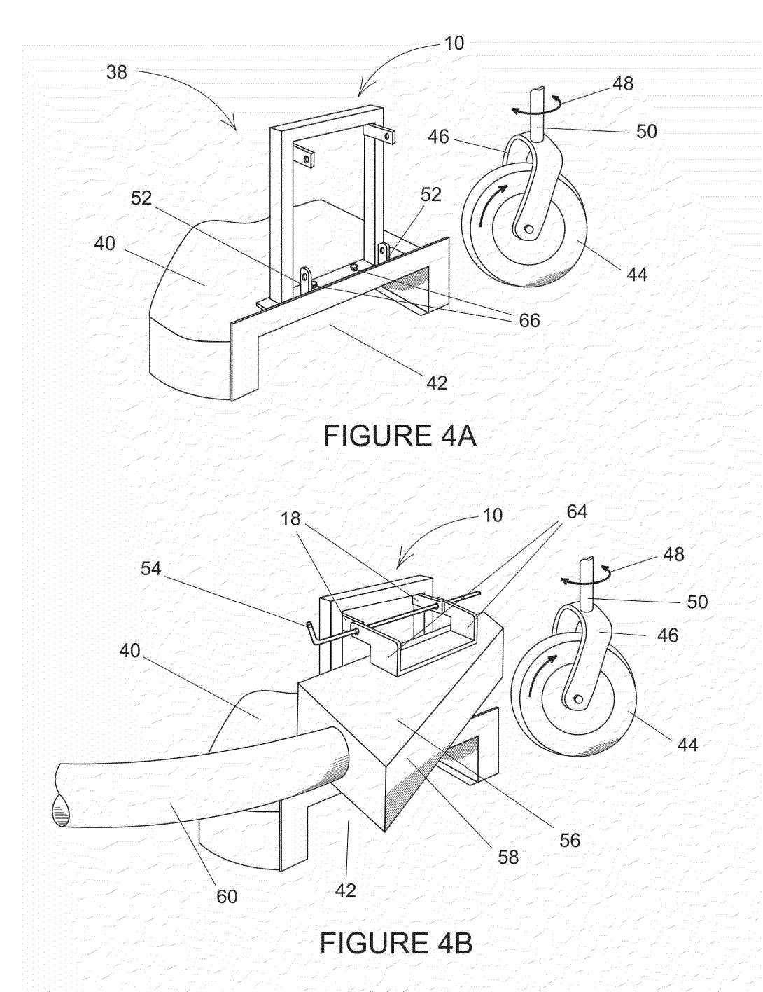

Turning now to FIG. 4A, the mounting bracket 10 according to the present disclosure is shown in oblique perspective view attached to the cutter deck 40 of the exemplary riding lawn mower 38. The mounting bracket 10 is attached to the cutter deck 40 by two screws 66 which pass through the holes 22 (see FIG. 1) and through two corresponding holes (not shown), which will have been drilled in the cutter deck 40, and engaging threaded nuts (out of view) beneath the cutter deck.

FIG. 4B shows, also in oblique perspective view, how the present apparatus 10 is used to store the vacuum pickup attachment 56 in a location that is removed from the path of material that is ejected from the exit portal 42. The vacuum attachment 56 is supported in that upper location by means of the same lynch pin 54 that can be used to hold the vacuum attachment in the lower location, as shown in FIG. 3B.

It is to be understood that the mounting bracket 10 is to be used on a variety of riding lawn mowers so as to hold a vacuum pickup attachment 56 in a storage location (FIG. 4B) when the user desires that the pickup attachment be disposed out of the path of the flow of material that emerges from the exit portal 42.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, circuits, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. A vacuum pickup attachment for a riding lawn mower, comprising:
the vacuum pickup attachment removably attached to the riding lawn mower for receiving lawn refuse;
the vacuum pickup attachment having a first position where a mouth of the vacuum pickup attachment is disposed at a first elevated location that is out of the way of the free flow of material that is moving through an exit portal of a cutter deck away from rotating blades disposed under the cutter deck of the riding lawn mower; and
the vacuum pickup attachment having a second position where the mouth of the vacuum pickup attachment is disposed at a second elevated location that is in the path of the stream of material that is being ejected through the exit portal by the rotating blades disposed under the cutter deck.

2. The vacuum pickup attachment of claim 1 wherein a mounting bracket for securing the vacuum pickup attachment to the riding lawn mower is mounted to the cutter deck of the riding lawn mower.

3. The vacuum pickup attachment of claim 2 wherein the mounting bracket has a base portion mounted to a top of the cutter deck of the riding lawn mower.

4. The vacuum pickup attachment of claim 3 wherein the mounting bracket includes:
two spaced upright portions extending away from the top of the cutter deck: and
two spaced upright portions joined by a horizontal top member.

5. The vacuum pickup attachment of claim 4 wherein the mounting bracket is a unitary rigid structure.

6. The vacuum pickup attachment of claim 5 wherein the mounting bracket is preferably made of steel.

7. The vacuum pickup attachment of claim 5 wherein two deck tabs, each having a hole adapted for receiving a lynch pin are disposed on the cutter deck.

8. The vacuum pickup attachment of claim 7 wherein the vacuum pickup attachment comprises:
a plenum chamber; and
a flexible vacuum-conveying pipe.

9. The vacuum pickup attachment of claim 8 wherein:
a plenum bracket having a base and two vertical portions is affixed to the plenum chamber; and
the plenum bracket having two holes in the vertical portions for connecting the vacuum pickup attachment to the cutter deck.

10. The vacuum pickup attachment of claim 9 wherein the vertical portions of the plenum bracket have end portions that project beyond the end surface of the plenum chamber.

11. The vacuum pickup attachment of claim 10 further including a lynch pin disposed though the two holes in the two vertical portions of the plenum bracket and the holes in the deck tabs on the cutter deck for removably securing the vacuum pickup attachment to the cutter deck tabs.

12. The vacuum pickup attachment of claim 11 wherein the lynch pin is disposed though the two holes in the two vertical portions of the end surface of the plenum is adjacent to the exit portal of the cutter deck.

13. A method of attaching a vacuum pickup attachment to a riding lawn mower, comprising:
removably attaching the vacuum pickup attachment removably to the riding lawn mower for receiving lawn refuse;
affixing the vacuum pickup attachment in a first position where a mouth of the vacuum pickup attachment is disposed at a first elevated location that is out of the way of the free flow of material that is moving through an exit portal of a cutter deck away from rotating blades disposed under the cutter deck of the riding lawn mower; and
affixing the vacuum pickup attachment in a second position where the mouth of the vacuum pickup attachment is disposed at a second elevated location that is in the path of the stream of material that is being ejected through the exit portal by the rotating blades disposed under the cutter deck.

14. The method of claim 13 including providing the vacuum pickup attachment with a plenum chamber with an end surface and a flexible vacuum-conveying pipe.

15. The method of claim 14 including securing the vacuum pickup attachment to a mounting bracket mounted to the cutter deck of the riding lawn mower.

16. The method of claim 15 including providing two deck tabs, each having a hole adapted for receiving a lynch pin on the cutter deck.

17. The method of claim 16 including providing a plenum bracket having a base and two vertical portions is affixed to the plenum chamber and wherein the plenum bracket has two holes in the vertical portions for connecting the vacuum pickup attachment to the cutter deck.

18. The method of claim 17 including disposing a lynch pin through the two holes in the two vertical portions of the plenum bracket and the holes in the deck tabs on the cutter deck whereby the vacuum pickup attachment is removably secured to the cutter deck tabs.

19. The method of claim 14 including disposing the end surface of the plenum away from the exit portal of the cutter deck when the vacuum pickup attachment is in the first position.

20. The method of claim 14 including disposing the end surface of the plenum is adjacent to the exit portal of the cutter deck when the vacuum pickup attachment is in a second position.
